(19) United States
(12) Patent Application Publication
(10) Pub. No.: US 2022/0091492 A1
(43) Pub. Date: Mar. 24, 2022

(54) WAVELENGTH CONVERSION ASSEMBLY, PROJECTION APPARATUS AND MANUFACTURING METHOD OF WAVELENGTH CONVERSION ASSEMBLY

(71) Applicant: Coretronic Corporation, Hsin-Chu (TW)

(72) Inventor: Wei-Hua Kao, Hsin-Chu (TW)

(73) Assignee: Coretronic Corporation, Hsin-Chu (TW)

(21) Appl. No.: 17/475,359

(22) Filed: Sep. 15, 2021

(30) Foreign Application Priority Data
Sep. 18, 2020 (CN) 202010985718.6

(51) Int. Cl. G03B 21/20; G03B 21/16

(52) U.S. Cl. CPC G03B 21/204; B23K 31/02; G03B 21/16

(57) ABSTRACT

A wavelength conversion assembly includes a substrate, a first element, a first welding structure, and a wavelength conversion layer. The first element is disposed on a first portion of the substrate. The first welding structure is located between the first portion of the substrate and the first element and partially connects the first portion and the first element as a whole. The wavelength conversion layer is disposed on a second portion of the substrate. The second portion of the substrate surrounds the first portion of the substrate. A projection apparatus and a manufacturing method of a wavelength conversion assembly are also provided. The first welding structure may withstand high temperatures. In this way, the first welding structure may not pollute other elements in a high temperature and high humidity environment, and service life of the wavelength conversion assembly is thereby increased.

### CROSS-REFERENCE TO RELATED APPLICATION

This application claims the priority benefit of China application serial no. 202010985718.6, filed on Sep. 18, 2020. The entirety of the above-mentioned patent application is hereby incorporated by reference herein and made a part of this specification.

### BACKGROUND

### Technical Field

The disclosure relates to an optical assembly, an optical apparatus, and a manufacturing method of the optical assembly, and in particular, to a wavelength conversion assembly, a projection apparatus, and a manufacturing method of the wavelength conversion assembly.

### Description of Related Art

Recently, projection apparatuses using solid-state light sources, such as a light emitting-diode (LED) and a laser diode, have progressively gained an important role in the market. Since the laser diode has a luminous efficiency greater than approximately 20%, laser light sources are gradually developed to be used to excite phosphors to produce pure-color light sources required by projectors in order to break through the light source limitation of light-emitting diodes.

Generally, an existing phosphor wheel has a wavelength conversion layer coated on a substrate. The substrate of the phosphor wheel is driven by a motor and then rotates around the axis. In this way, different regions of the phosphor wheel cut into the transmission path of the light beam provided by the laser light source to form the converted light.

Nevertheless, in the existing method of assembling and fixing the phosphor wheel, elements such as the substrate and the motor are usually bonded with an adhesive material. The adhesive material, however, is not resistant to high temperatures and may deteriorate. When the adhesive material is at a high temperature for a long time, the adhesive material cannot withstand the high temperature and may easily cause deterioration or burnout, which will affect the operation balance of the motor in the phosphor wheel and may pollute internal elements in the phosphor wheel as well. It thus can be seen that the phosphor wheel is not suitable for high-power projection apparatuses. Besides, the existing high-temperature-resistant adhesive materials require a long curing time, such that the overall process time is required to be extended, and production costs of products are thus increased.

The information disclosed in this BACKGROUND section is only for enhancement of understanding of the background of the described technology and therefore it may contain information that does not form the prior art that is already known to a person of ordinary skill in the art. Further, the information disclosed in the BACKGROUND section does not mean that one or more problems to be resolved by one or more embodiments of the disclosure was acknowledged by a person of ordinary skill in the art.

### SUMMARY

The disclosure provides a wavelength conversion assembly exhibiting favorable reliability.

The disclosure provides a projection apparatus having the above wavelength conversion assembly.

The disclosure provides a manufacturing method of a wavelength conversion assembly capable of manufacturing the above wavelength conversion assembly.

Other objects and advantages of the disclosure may be further illustrated by the technical features broadly embodied and described as follows.

In order to achieve one or part of or all of the features, an embodiment of the disclosure provides a wavelength conversion assembly. The wavelength conversion assembly includes a substrate, a first element, a first welding structure, and a wavelength conversion layer. The first element is disposed on a first portion of the substrate. The first welding structure is located between the first portion of the substrate and the first element and partially connects the first portion and the first element as a whole. The wavelength conversion layer is disposed on a second portion of the substrate, and the second portion of the substrate surrounds the first portion of the substrate.

In order to achieve one or part of or all of the features, an embodiment of the disclosure provides a projection apparatus. The projection apparatus includes a light source, a wavelength conversion assembly, a light valve, and a projection lens. The light source is configured to emit an illumination light beam. The wavelength conversion assembly is disposed in an optical path of the illumination light beam and is configured to convert the illumination light beam into a converted light beam. The wavelength conversion assembly includes a substrate, a first element, a first welding structure, and a wavelength conversion layer. The first element is disposed on a first portion of the substrate. The first welding structure is located between the first portion of the substrate and the first element and partially connects the first portion and the first element as a whole. The wavelength conversion layer is disposed on a second portion of the substrate, and the second portion of the substrate surrounds the first portion of the substrate. The light valve is disposed in an optical path of the converted light beam and is configured to adjust the converted light beam into a projection light beam. The projection lens is disposed in an optical path of the projection light beam to project the projection light beam.

In order to achieve one or part of or all of the features, an embodiment of the disclosure provides a manufacturing method of a wavelength conversion assembly, and the manufacturing method includes the following steps. A first element is disposed on a first portion of a substrate. first element, and the first welding structure partially connects the first portion and the first element as a whole. A wavelength conversion layer is disposed on a second portion of the substrate, and the second portion of the substrate surrounds the first portion of the substrate.

To sum up, the embodiments of the disclosure have at least one of the following advantages or effects. In the embodiments of the disclosure, the first welding structure of the wavelength conversion assembly in the projection apparatus partially connects the substrate and the first element as a whole. That is, the substrate partially contacts the first element only, so that a favorable heat insulating effect is provided. In addition, compared to an existing adhesive material, the first welding structure may withstand high temperatures. In this way, the first welding structure may not cause mass loss or pollute other elements in a high temperature and high humidity environment, and service life of the wavelength conversion assembly is thereby increased. Further, compared to an existing adhesive material, the process time required by the first welding structure is short, production costs of the wavelength conversion assembly are therefore reduced and flexibility of the process is improved.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a structure of a projection apparatus according to an embodiment of the disclosure.

FIG. 2A is a schematic cross-sectional side view of a wavelength conversion assembly of the projection apparatus in FIG. 1.

FIG. 2B is a schematic enlargement view of a partial region of the wavelength conversion assembly in FIG. 2A.

FIG. 3 is a schematic three-dimensional view of the wavelength conversion assembly in FIG. 2A.

FIG. 4 is a schematic three-dimensional view of a wavelength conversion assembly according to another embodiment of the disclosure.

FIG. 5 is a schematic three-dimensional view of a wavelength conversion assembly according to another embodiment of the disclosure.

FIG. 6 is a schematic flow chart of a manufacturing method of a wavelength conversion assembly according to an embodiment of the disclosure.

FIG. 7A to FIG. 7C are schematic views of a process of a welding method.

FIG. 8A to FIG. 8C are schematic views of a process of another welding method.

FIG. 9A to FIG. 9C are schematic views of a process of still another welding method.

FIG. 10A to FIG. 10C are schematic views of a process of another welding method.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

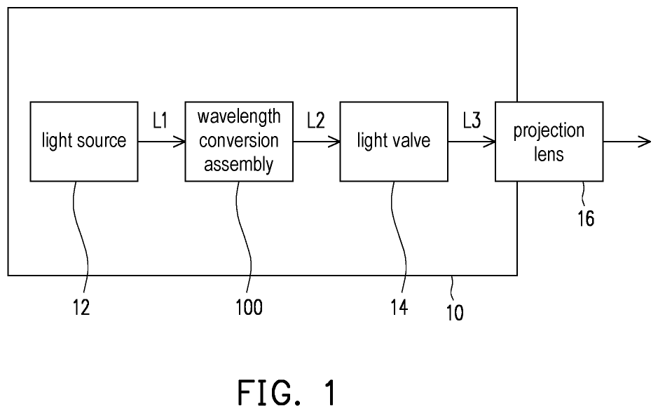

FIG. 1 is a schematic view of a structure of a projection apparatus according to an embodiment of the disclosure. With reference to FIG. 1, a projection apparatus 10 provided by this embodiment includes a light source 12, a wavelength conversion assembly 100, a light valve 14, and a projection lens 16. The light source 12 is configured to emit an illumination light beam L1. For instance, the light source 12 includes a plurality of light-emitting elements, and each of the light-emitting elements is formed by a single or a plurality of laser diodes (LDs) or light-emitting diodes (LEDs), which should however not be construed as limitations to the disclosure.

The wavelength conversion assembly 100 is disposed in an optical path of the illumination light beam L1 and is configured to convert the illumination light beam L1 into a converted light beam L2. The light valve 14 is disposed in an optical path of the converted light beam L2 and is configured to adjust the converted light beam L2 into a projection light beam L3.

For instance, the light valve 14 is, for example a reflective light modulator such as a liquid crystal on silicon panel (LCoS panel) and a digital micro-mirror device (DMD). In some embodiments, the light valve 14 may also be, for example, a transmissive light modulator such as a transparent liquid crystal panel, an electro-optical modulator, a magneto-optic modulator, and an acousto-optic modulator (AOM). A form and a type of the light valve 14 is not particularly limited in the disclosure.

The projection lens 16 is disposed in an optical path of the projection light beam L3 to project the projection light beam L3 onto a screen or a wall (not shown). For instance, the projection lens 16 includes, for example, one or a plurality of optical lens combinations with refracting powers including various non-planar lens combinations of a biconcave lens, a biconvex lens, a concave-convex lens, a convex-concave lens, a plane-convex lens, and a plane-concave lens, for example. In an embodiment, the projection lens 16 may further include a planar optical lens, so as to project the projection light beam L3 from the light valve 14 to the projection target through reflection or transmission. A form and a type of the projection lens 16 is not particularly limited in the disclosure.

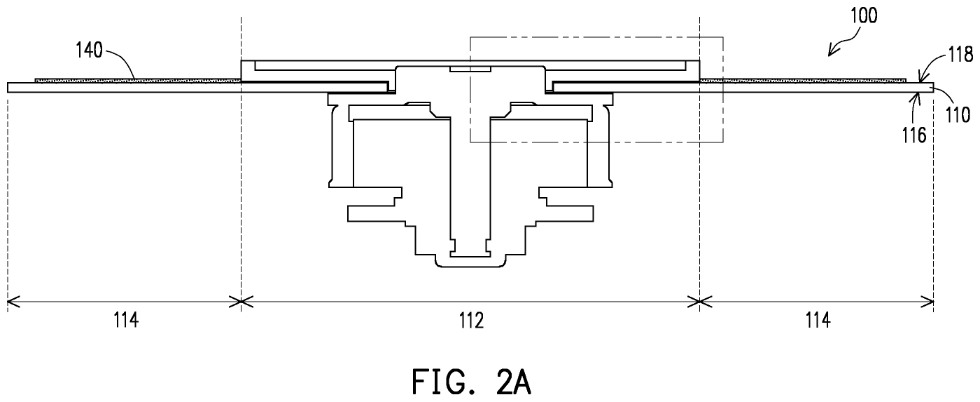

FIG. 2A is a schematic cross-sectional side view of a wavelength conversion assembly of the projection apparatus in FIG. 1. FIG. 2B is a schematic enlargement view of a partial region of the wavelength conversion assembly in FIG. 2A. With reference to FIG. 2A and FIG. 2B, in this embodiment, the wavelength conversion assembly 100 includes a substrate 110, a first element 120, first welding structures 130 and 132, and a wavelength conversion layer 140. The wavelength conversion layer 140 receives the illumination light beam L1 from the light source 12. The substrate 110 may be divided into a first portion 112 and a second portion 114. The first portion 112 is a center portion of the substrate 110, and the second portion 114 is a periphery portion of the first portion 112 surrounding the substrate 110. The second portion 114 of the substrate 110 surrounds the first portion 112 of the substrate 110. The first element 120 is disposed on the first portion 112 of the substrate 110. The first welding structures 130 and 132 are located between the first portion 112 of the substrate 110 and the first element 120 and partially connect the first portion 112 and the first element 120 as a whole. The wavelength conversion layer 140 is disposed on a second portion 114 of the substrate 110. In an embodiment, the wavelength conversion layer 140 includes at least one wavelength conversion region configured to convert the illumination light beam L1 into the converted light beam L2, and a number of the wavelength conversion region may be designed according to actual needs. In another embodiment, the wavelength conversion layer 140 includes plural wavelength conversion regions. To be specific, as shown in FIG. 2B, in this embodiment, the substrate 110 has a first surface 116 and a second surface 118 opposite to each other. The first element 120 includes a motor body 122 located on the first surface 116 of the substrate 110 and a motor fixing member 124 located on the second surface 118 of the substrate 110. The motor body 122 of the first element 120 and the first surface 116 of the substrate 110 are partially connected as a whole through the first welding structure 132. The motor fixing member 124 of the first element 120 and the second surface 118 of the substrate 110 are partially connected as a whole through the first welding structures 130.

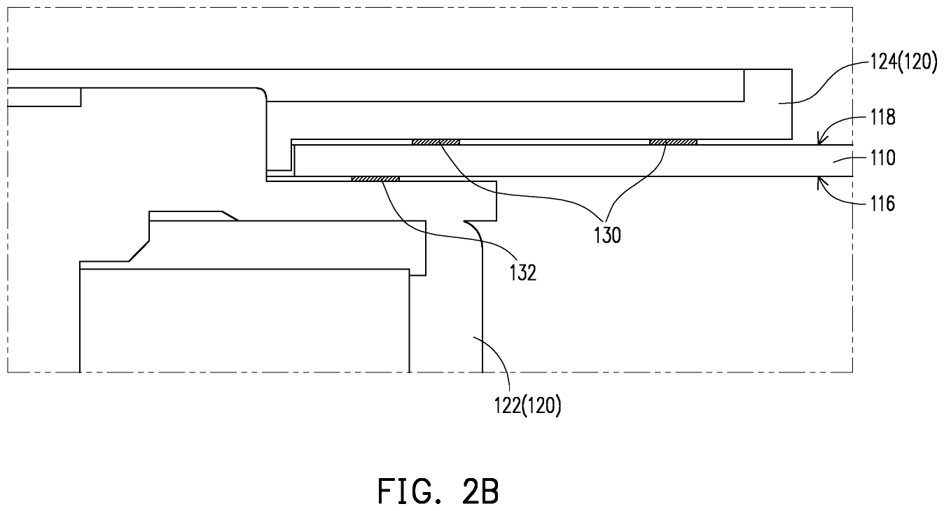

FIG. 3 is a schematic three-dimensional view of the wavelength conversion assembly in FIG. 2A. To be specific, as shown in FIG. 3, in this embodiment, the first welding structure 130 of the wavelength conversion assembly 100 includes a plurality of dot patterns and is evenly distributed on the first portion 112 of the substrate 110. An area occupied by the first welding structure 130 of the wavelength conversion assembly 100 on the first portion 112 of the substrate 110 is less than half of an area of the first portion 112.

In an embodiment, the area occupied by the first welding structure 130 of the wavelength conversion assembly 100 on the first portion 112 of the substrate 110 is between 3% and 20% of the area of the first portion 112. The above numerical range may be used to control a contact region between the substrate 110 and the first element 120 to be within a specific range, and in this way, favorable connecting strength and heat insulating effect are provided between the substrate 110 and the first element 120. Such that, when the wavelength conversion assembly 100 is operating, heat energy produced by the substrate 110 may not be transmitted to the motor body 122 to excessively heat the motor body 122.

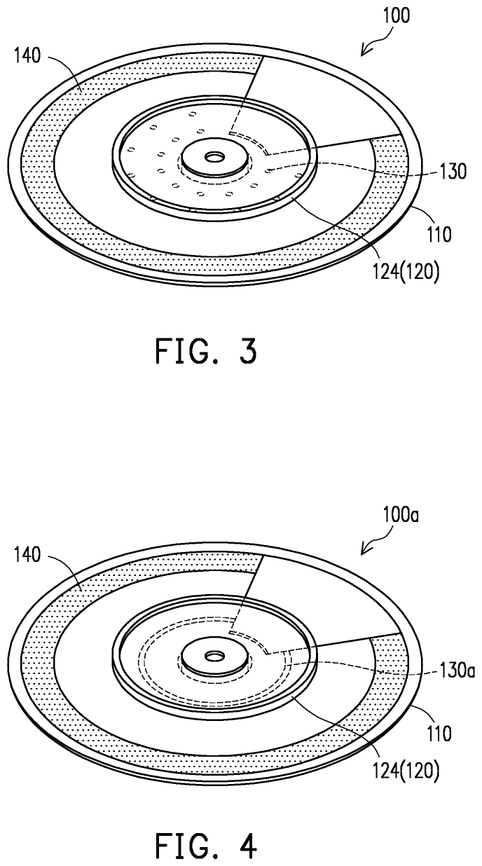

FIG. 4 is a schematic three-dimensional view of a wavelength conversion assembly according to another embodiment of the disclosure. As shown in FIG. 4, in this embodiment, a first welding structure 130a of a wavelength conversion assembly 100a includes at least one ring pattern. Note that regarding a shape of the first welding structure 130a, the pattern may be changed according to usage needs, linear pattern, irregular pattern, etc. may also be adopted, for example, and a type of the pattern is not particularly limited herein.

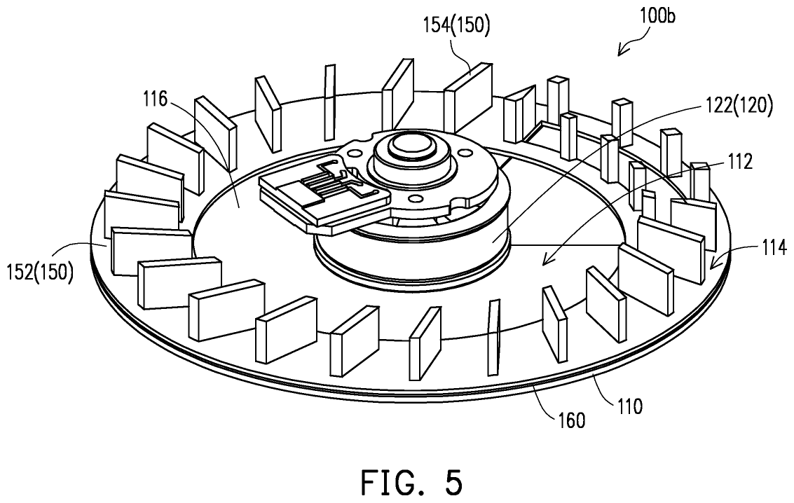

FIG. 5 is a schematic three-dimensional view of a wavelength conversion assembly according to another embodiment of the disclosure. Note that a viewing angle of FIG. 5 is a viewing angle of the back of FIG. 3 and FIG. 4. As shown in FIG. 5, in this embodiment, a wavelength conversion assembly 100b further includes a heat dissipation structure 150 and a second welding structure 160. The heat dissipation structure 150 has a bottom board 152 and a fin 154. The heat dissipation structure 150 is disposed on the second portion 114 of the substrate 110 and is located on the first surface 116. The second welding structure 160 is located between an entire bottom surface of the bottom board 152 of the heat dissipation structure 150 and the substrate 110 to connect the heat dissipation structure 150 and the substrate 110.

To be specific, as shown in FIG. 5, the heat dissipation structure 150 is disposed on the second portion 114 of the substrate 110 and is located on the first surface 116, and the wavelength conversion layer 140 is disposed on the second portion 114 of the substrate 110 and is located on the second surface 118. When a laser light source irradiates the wavelength conversion layer 140, the wavelength conversion layer 140 forms a converted beam and produces heat energy. At this time, the heat energy produced by the wavelength conversion layer 140 may be conducted to the heat dissipation structure 150 through the second welding structure 160. Since the second welding structure 160 is located on the entire bottom surface of the bottom board 152 of the heat dissipation structure 150, the heat energy produced by the wavelength conversion layer 140 is conducted to the heat dissipation structure 150 through the substrate 110 and the second welding structure 160. In this way, the chance of that the heat energy being conducted to the first element 120 of the first portion 112 of the substrate 110 is reduced, and the motor body 112 of the first element 120 is thus protected. The fin 154 is configured to increase a heat dissipation area to facilitate fast heat dissipation.

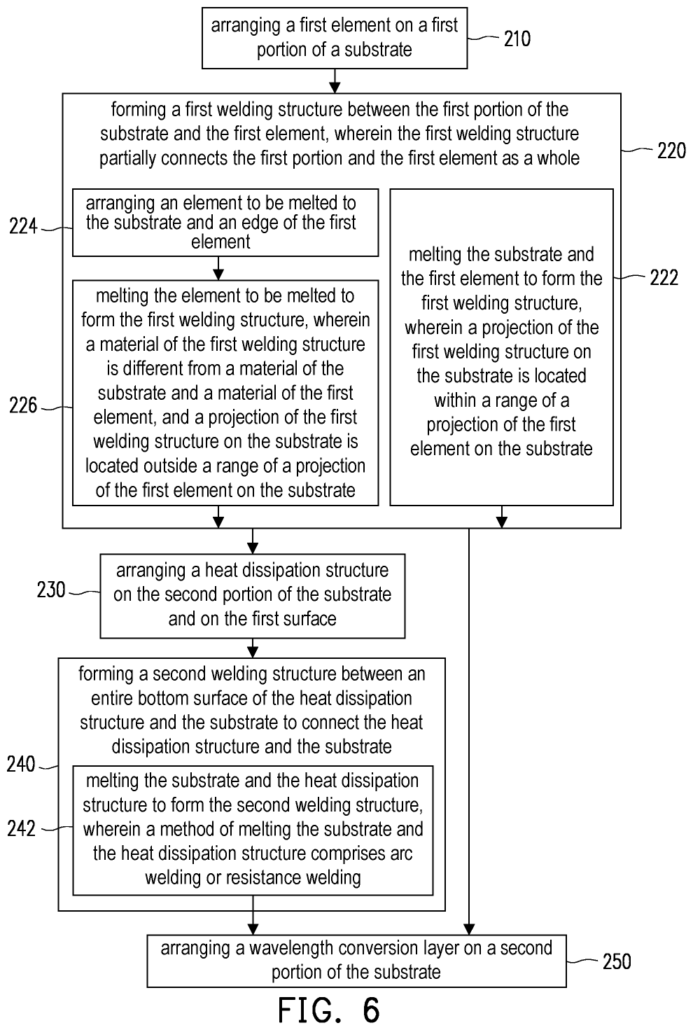

FIG. 6 is a schematic flow chart of a manufacturing method of a wavelength conversion assembly according to an embodiment of the disclosure. The manufacturing method of the wavelength conversion assembly provided by this embodiment is at least suitable to the wavelength conversion assemblies 100, 100a, and 100b respectively provided in FIG. 3, FIG. 4, and FIG. 5, which should however not be construed as limitations to the disclosure. The manufacturing method of the wavelength conversion assemblies 100, 100a, and 100b is described through FIG. 6 including steps 210 to 250. For instance, a manufacturing method of the wavelength conversion assemblies 100 and 100a is provided.

With reference to FIG. 6, in step 210, the first element 120 is disposed on the first portion 112 of the substrate 110. Next, in step 220, the first welding structure 130 is formed between the first portion 112 of the substrate 110 and the first element 120, and the first welding structure 130 partially connects the first portion 112 and the first element 120 as a whole. To be specific, step 220 may include step 222. In step 222, the substrate 110 and the first element 120 are melted to form the first welding structure 130. A projection of the first welding structure 130 on the substrate 110 is located within a range of a projection of the first element 120 on the substrate 110.

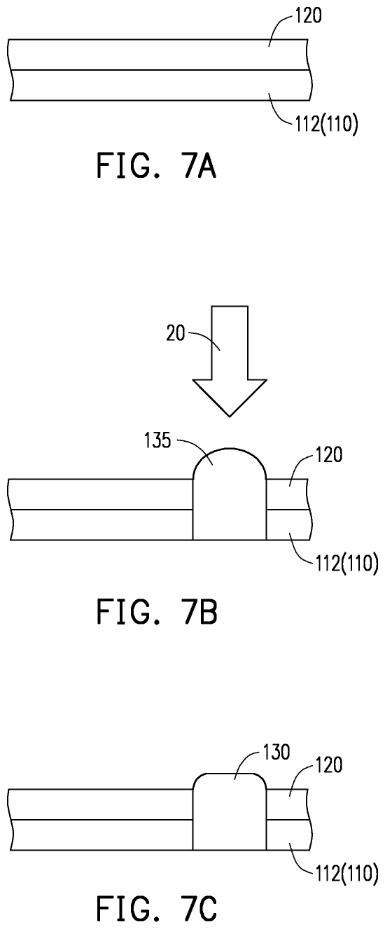

To be specific, FIG. 7A to FIG. 7C are schematic views of a process of a welding method. With reference to FIG. 7A to FIG. 7C, laser welding is adopted in this embodiment. An overlapping region between the first element 120 and the first portion 112 of the substrate 110 is irradiated by a laser 20. The first element 120 and the first portion 112 of the substrate 110 in an irradiation path of the laser 20 are melted to form a melted portion 135. After the melted portion 135 is cooled, the first welding structure 130 constituted by a material of the first element 120 and a material of the substrate 110 is thereby formed. In this embodiment, the first welding structure 130 completely penetrates the substrate 110 and the first element 120 and is exposed outside the substrate 110 and the first element 120. Besides, laser welding may be applied to the first welding structure 130 of a specific pattern (such as, but not limited to, a dot pattern, a linear pattern, and other high-precision patterns and the like) due to high accuracy of laser welding.

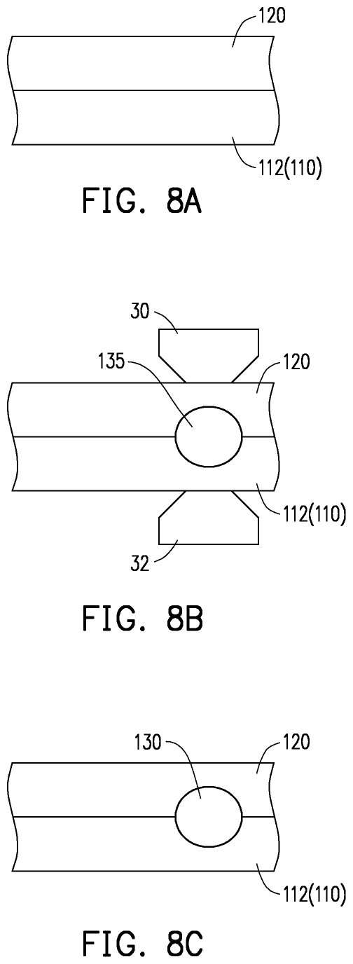

FIG. 8A to FIG. 8C are schematic views of a process of another welding method. As shown in FIG. 8A to FIG. 8C, impedance welding is adopted in this embodiment. An electrode 30 is propped against and aligned with a surface of the first element 120 opposite to the substrate 110 and a surface of the substrate 110 opposite to the first element 120, such that a current passes through the overlapping region between the first element 120 and the first portion 112 of the substrate 110. At a junction of the first element 120 and the first portion 112 of the substrate 110, as a resistance characteristic brings high temperature, the melted portion 135 is limited to be located at the junction of the first element 120 and the first portion 112 of the substrate 110. After the current is turned off and the melted portion 135 is cooled, the first welding structure 130 constituted by the material of the first element 120 and the material of the substrate 110 is formed. In this embodiment, the first welding structure 130 is covered by the substrate 110 and the first element 120.

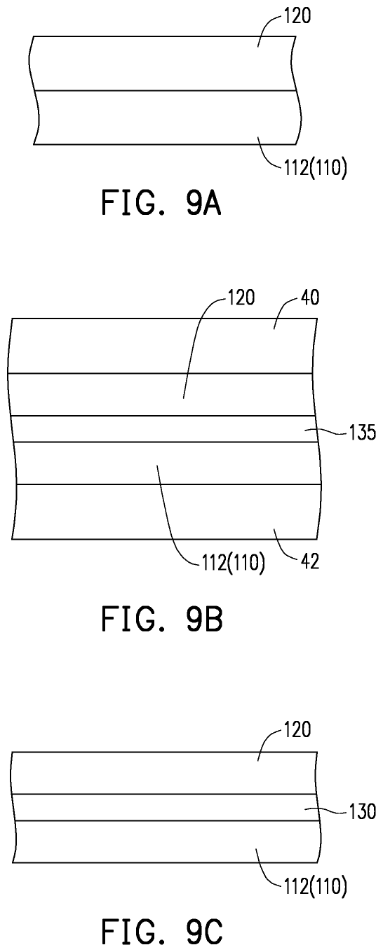

FIG. 9A to FIG. 9C are schematic views of a process of still another welding method. As shown in FIG. 9A to FIG. 9C, vibration welding is adopted in this embodiment. The overlapping first element 120 and the substrate 110 are placed in vibration molds 40 and 42 opposite to each other and are subjected to vibration. Herein, the vibration mold 40 is propped against the surface of the first element 120 opposite to the substrate 110, and the vibration mold 42 is propped against the surface of the substrate 110 opposite to the first element 120. A temperature of the junction of the first element 120 and the first portion 112 of the substrate 110 is raised by the vibration, such that the first element 120 and the first portion 112 of the substrate 110 are melted, and the melted portion 135 is formed. After the melted portion 135 is cooled, the first welding structure 130 constituted by the material of the first element 120 and the material of the substrate 110 is formed. In this embodiment, the first welding structure 130 is covered by the substrate 110 and the first element 120.

Note that as shown in FIG. 7C, FIG. 8C, and FIG. 9C, the first welding structure 130 is formed by melting the material of the substrate 110 and the material of the first element 120, and the projection of the first welding structure 130 on the substrate 110 is located within the range of the projection of the first element 120 on the substrate 110. In addition, the first element 120 and the substrate 110 are both made of metal or polymer materials. Certainly, the materials of the first element 120 and the substrate 110 are not limited to the above.

In addition, as shown in FIG. 8C and FIG. 9C, the first welding structure 130 is formed at the junction of the first element 120 and the first portion 112 of the substrate 110, the first welding structure 130 may not damage the surfaces of the first element 120 and the substrate 110.

With reference to FIG. 6 again, step 220 may further include step 224 and step 226. In step 224, an element to be melted is arranged to the substrate 110 and an edge of the first element 120. Next, in step 226, the element to be melted is melted to form the first welding structure 130. A material of the first welding structure 130 is different from the material of the substrate 110 and the material of the first element 120, and the projection of the first welding structure 130 on the substrate 110 is located outside the range of the projection of the first element 120 on the substrate 110.

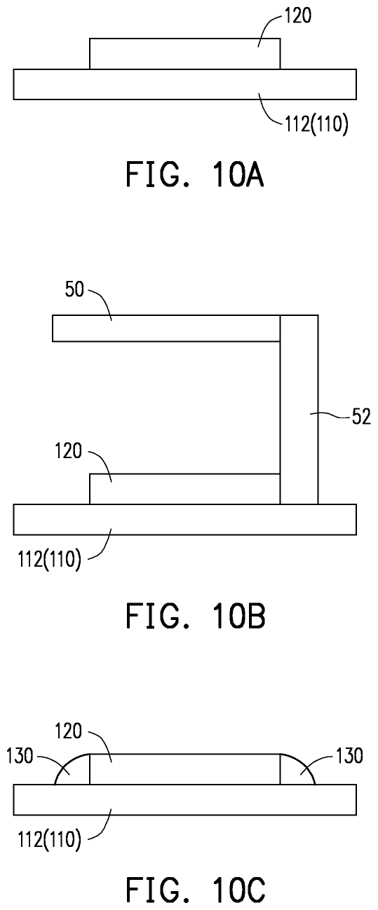

To be specific, FIG. 10A to FIG. 10C are schematic views of a process of another welding method. As shown in FIG. 10A to FIG. 10C, a melted element is, for example, a solder 52 in this embodiment. A welding gun 50 is energized to heat and melt the solder 52, and the solder 52 is arranged on the substrate 110 and at the edge of the first element 120. The power of the welding gun 50 is then turned off, and the first welding structure 130 is formed after the solder 52 is cooled. Nevertheless, the disclosure is not limited to this welding method.

Note that as shown in FIG. 7A to FIG. 10C, since the first welding structure 130 is formed by melting the substrate 110 and the first element 120 or by melting the solder 52, the first welding structure 130 may withstand high temperatures, for example, a high temperature above 200° C., which is higher than specifications of an existing adhesive material. Further, time required by a process of the first welding structure 130 is, for example, 3 to 5 minutes, which is lower than time required by the process of an existing adhesive material. In this way, compared to an existing adhesive material, the first welding structure 130 may not deteriorate or lose materials in a high temperature and high humidity environment and thus is prevented from polluting other internal elements or affecting an operation balance of the first element 120. In addition, the process time may be reduced through such manufacturing method, and the use of adhesive materials may be omitted so that manufacturing costs are thereby lowered.

Note that regarding the welding method of forming the first welding structure 130, laser welding, arc welding, resistance welding, electron beam welding, soldering and brazing welding, friction welding, or ultrasonic welding may be included to melt the substrate 110 and the first element 120 or to melt the solder 52 to form the first welding structure 130. Certainly, the welding method is not particularly limited.

With reference to FIG. 3, FIG. 4, and FIG. 6, in the embodiments of FIG. 3 and FIG. 4, step 250 is performed next. The wavelength conversion layer 140 is disposed on the second portion 114 of the substrate 110. The second portion 114 of the substrate 110 surrounds the first portion 112 of the substrate 110, and manufacturing of the wavelength conversion assemblies 100 and 100a is thus completed.

In the embodiment of FIG. 5, for example, with reference to FIG. 5 and FIG. 6, step 230 and step 240 may be performed before or after step 250. In step 230, the heat dissipation structure 150 is disposed on the second portion 114 of the substrate 110 and is located on the first surface 116. Next, in step 240, the second welding structure 160 is located between the entire bottom surface of the heat dissipation structure 150 and the substrate 110 to connect the heat dissipation structure 150 and the substrate 110.

In this embodiment, step 240 further includes step 242. In step 242, the substrate 110 and the heat dissipation structure 150 are melted to form the second welding structure 160. A method of melting the substrate 110 and the heat dissipation structure 150 includes arc welding or resistance welding. Costs of arc welding or resistance welding are low, and arc welding or resistance welding may thus be applied to whole-surface welding. Therefore, arc welding or resistance welding may be selected to perform welding of the second welding structure 160 which is arranged on the whole surface.

In view of the foregoing, the embodiments of the disclosure have at least one of the following advantages or effects. In the embodiments of the disclosure, the first welding structure of the wavelength conversion assembly in the projection apparatus partially connects the substrate and the first element as a whole. That is, the substrate partially contacts the first element only, so that a favorable heat insulating effect is provided. In addition, compared to an existing adhesive material, the first welding structure may withstand high temperatures. In this way, the first welding structure may not cause mass loss or pollute other elements in a high temperature and high humidity environment, and service life of the wavelength conversion assembly is thereby increased. Further, compared to an existing adhesive material, the process time required by the first welding structure is short, production costs of the wavelength conversion assembly are therefore reduced and flexibility of the process is improved.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A wavelength conversion assembly, comprising a substrate, a first element, a first welding structure, and a wavelength conversion layer, wherein:
the first element is disposed on a first portion of the substrate,
the first welding structure is located between the first portion of the substrate and the first element and partially connects the first portion and the first element as a whole, and
the wavelength conversion layer is disposed on a second portion of the substrate, the second portion of the substrate surrounds the first portion of the substrate.

2. The wavelength conversion assembly according to claim 1, wherein the first welding structure is formed by melting a material of the substrate and a material of the first element, and a projection of the first welding structure on the substrate is located within a range of a projection of the first element on the substrate.

3. The wavelength conversion assembly according to claim 2, wherein the first welding structure completely penetrates the substrate and the first element and is exposed outside the substrate and the first element, or the first welding structure is covered by the substrate and the first element.

4. The wavelength conversion assembly according to claim 1, wherein a material of the first welding structure is different from a material of the substrate and a material of the first element, and a projection of the first welding structure on the substrate is located outside a range of a projection of the first element on the substrate.

5. The wavelength conversion assembly according to claim 1, wherein the substrate has a first surface and a second surface opposite to each other, and the first element comprises a motor body located on the first surface or a motor fixing member located on the second surface.

6. The wavelength conversion assembly according to claim 1, wherein the first welding structure comprises a plurality of dot patterns or at least one ring pattern.

7. The wavelength conversion assembly according to claim 1, wherein the first welding structure is evenly distributed on the first portion.

8. The wavelength conversion assembly according to claim 1, wherein an area occupied by the first welding structure on the first portion is less than half of an area of the first portion.

9. The wavelength conversion assembly according to claim 1, wherein an area occupied by the first welding structure on the first portion is between 3% and 20% of an area of the first portion.

10. The wavelength conversion assembly according to claim 1, further comprising:
a heat dissipation structure, wherein the substrate comprises a first surface and a second surface opposite to each other, the wavelength conversion layer is disposed on the second surface of the substrate, the heat dissipation structure is disposed on the second portion of the substrate and is located on the first surface; and
a second welding structure, located between an entire bottom surface of the heat dissipation structure and the substrate to connect the heat dissipation structure and the substrate.

11. A projection apparatus, comprising a light source, a wavelength conversion assembly, a light valve, and a projection lens, wherein:
the light source is configured to emit an illumination light beam,
the wavelength conversion assembly is disposed in an optical path of the illumination light beam and is configured to convert the illumination light beam into a converted light beam, the wavelength conversion assembly comprises a substrate, a first element, a first welding structure, and a wavelength conversion layer, wherein:
the first element is disposed on a first portion of the substrate,
the first welding structure is located between the first portion of the substrate and the first element and partially connects the first portion and the first element as a whole, and
the wavelength conversion layer is disposed on a second portion of the substrate, the second portion of the substrate surrounds the first portion of the substrate,
the light valve is disposed in an optical path of the converted light beam and is configured to adjust the converted light beam into a projection light beam, and
the projection lens is disposed in an optical path of the projection light beam to project the projection light beam.

12. A manufacturing method of a wavelength conversion assembly, comprising:
arranging a first element on a first portion of a substrate;
forming a first welding structure between the first portion of the substrate and the first element, wherein the first welding structure partially connects the first portion and the first element as a whole; and
arranging a wavelength conversion layer on a second portion of the substrate, wherein the second portion of the substrate surrounds the first portion of the substrate.

13. The manufacturing method of the wavelength conversion assembly according to claim 12, wherein the step of forming the first welding structure further comprises:
melting the substrate and the first element to form the first welding structure, wherein a projection of the first welding structure on the substrate is located within a range of a projection of the first element on the substrate.

14. The manufacturing method of the wavelength conversion assembly according to claim 13, wherein a method of melting the substrate and the first element comprises laser welding, arc welding, resistance welding, electron beam welding, soldering and brazing welding, friction welding, or ultrasonic welding.

15. The manufacturing method of the wavelength conversion assembly according to claim 13, wherein the first element and the substrate are both made of metal or polymer materials.

16. The manufacturing method of the wavelength conversion assembly according to claim 12, wherein the step of forming the first welding structure further comprises:
arranging an element to be melted to the substrate and an edge of the first element; and
melting the element to be melted to form the first welding structure, wherein a material of the first welding structure is different from a material of the substrate and a material of the first element, and a projection of the first welding structure on the substrate is located outside a range of a projection of the first element on the substrate.

17. The manufacturing method of the wavelength conversion assembly according to claim 12, wherein the first welding structure comprises a plurality of dot patterns or at least one ring pattern.

18. The manufacturing method of the wavelength conversion assembly according to claim 12, wherein an area occupied by the first welding structure on the first portion is less than half of an area of the first portion.

19. The manufacturing method of the wavelength conversion assembly according to claim 12, wherein the substrate comprises a first surface and a second surface opposite to each other, the wavelength conversion layer is disposed on the second surface of the substrate, and the manufacturing method further comprises:
arranging a heat dissipation structure on the second portion of the substrate and on the first surface; and
forming a second welding structure between an entire bottom surface of the heat dissipation structure and the substrate to connect the heat dissipation structure and the substrate.

20. The manufacturing method of the wavelength conversion assembly according to claim 19, wherein the step of forming the second welding structure further comprises:
melting the substrate and the heat dissipation structure to form the second welding structure, wherein a method of melting the substrate and the heat dissipation structure comprises arc welding or resistance welding.
